(19) United States
(12) Patent Application Publication
(10) Pub. No.: US 2015/0111064 A1
(43) Pub. Date: Apr. 23, 2015

(54) HIGH-STRENGTH HOT-DIP GALVANIZED STEEL SHEET AND HIGH-STRENGTH ALLOYED HOT-DIP GALVANIZED STEEL SHEET HAVING EXCELLENT BENDING WORKABILITY AND MINIMAL STRENGTH DIFFERENCE BETWEEN CENTER PART AND END PARTS IN SHEET WIDTH DIRECTION, AND METHOD FOR MANUFACTURING SAME

(71) Applicant: KABUSHIKI KAISHA KOBE SEIKO SHO(KOBE STEEL, LTD.), Kobe-shi, Hyogo (JP)

(72) Inventors: Muneaki Ikeda, Kakogawa-shi (JP); Masaaki Miura, Kakogawa-shi (JP)

(73) Assignee: KABUSHIKI KAISHA KOBE SEIKO SHO(KOBE STEEL, LTD.), Kobe-shi, Hyogo (JP)

(21) Appl. No.: 14/382,489

(22) PCT Filed: Mar. 22, 2013
(86) PCT No.: PCT/JP2013/058355

§ 371 Date: Sep. 2, 2014

(30) Foreign Application Priority Data
Mar. 27, 2012 (JP) 2012-072543

(51) Int. Cl. C23C 2/02; C22C 38/58; C22C 38/54; C22C 38/50; C22C 38/42; C22C 38/38; C22C 38/32; C22C 38/28; C22C 38/26; C22C 38/24; C22C 38/22; C22C 38/16; C22C 38/14; C22C 38/12; C22C 38/08; C22C 38/06; C22C 38/04; C22C 38/02; C22C 38/00; B32B 15/01; C21D 9/46

(52) U.S. Cl. CPC C23C 2/02; C21D 9/46; C22C 38/58; C22C 38/54; C22C 38/50; C22C 38/42; C22C 38/38; C22C 38/32; C22C 38/28; C22C 38/26; C22C 38/24; C22C 38/22; C22C 38/16; C22C 38/14; C22C 38/12; C22C 38/08; C22C 38/06; C22C 38/04; C22C 38/02; C22C 38/001; B32B 15/013
USPC 428/659; 148/533

(57) ABSTRACT

Provided are: a high-strength hot-dip galvanized steel sheet in which bending workability of the high-strength hot-dip galvanized steel sheet is improved, and in which strength difference between a center part and end parts in the sheet width direction is reduced; and a method for manufacturing a high-strength hot-dip galvanized steel sheet. The steel sheet is a hot-dip galvanized steel sheet having a hot-dip galvanizing layer on a surface of a base steel sheet containing: C, Mn, P, S, and Al; Ti and B in amounts satisfying equation (1); and N; and Si as needed; the remainder comprising iron and unavoidable impurities; the metallographic structure of the base steel sheet having martensite, bainite, and ferrite, the ratios of each with respect to the overall metallographic structure being 50 area % or more of the martensite, 15-50 area % of the bainite, and 5 area % or less of the ferrite,

0.005×[Mn]+0.02×[B]^{1/2}+0.025≦[Ti]≦0.15. (1)

### TECHNICAL FIELD

The present invention relates to a high-strength hot-dip galvanized steel sheet, a high-strength alloyed hot-dip galvanized steel sheet, and a method for manufacturing each of these steel sheets.

### BACKGROUND ART

High-strength steel sheets are used for automobiles, transport machinery, furnishings, building materials, and other articles in wide fields. For realizing a decrease in the fuel consumption of, for example, automobiles, transport machinery and others, it is desired to use a high-strength steel sheet to lighten the automobiles and the others. Collision safety is also desired for automobiles and others. Thus, their structural members such as their pillars, and their reinforcing members such as bumpers and impact beams are required to have a higher strength.

Out of such high-strength steel sheets, the following is used for members for which rust preventing performance is required: a high-strength hot-dip galvanized steel sheet (referred to merely as a GI steel sheet), which has a hot-dip galvanization layer formed on a surface of a basic steel sheet; or a high-strength alloyed hot-dip galvanized steel sheet (referred to merely as a GA steel sheet), which is obtained by subjecting a GI steel sheet to alloying treatment.

However, in a case where such steel sheets have been heightened in strength, a problem is caused that the steel sheets are easily cracked when bent, that is, the steel sheets are deteriorated in bending workability.

Thus, such steel sheets are requested to be improved in strength without being deteriorated in bending workability.

Patent Literatures 1 to 3 disclose techniques for heightening a GI steel sheet in strength without being deteriorated in bending strength. However, the metallic microstructure of the GI steel sheet disclosed in each of these literatures contains ferrite in a large proportion. Thus, the steel sheet may not gain a desired strength.

The inventors have also suggested, in Patent Literature 4, a super-high strength steel sheet having a tensile strength of 1100 MPa or more and having an excellent bending workability. This super-high strength steel sheet contains Si in a proportion of 0.5 to 2.5% and has a steel-sheet metallic microstructure containing martensite and a soft phase of bainitic ferrite and polygonal ferrite.

### CITATION LIST

### Patent Literatures

[Patent Literature 1] JP 2010-275628 A

[Patent Literature 2] JP 2008-280608 A

[Patent Literature 3] JP 2009-149937 A

[Patent Literature 4] JP 2011-225975 A

### SUMMARY OF INVENTION

### Technical Problem

A GI steel sheet as described above is usually produced by subjecting a cold rolled steel sheet to soak treatment, cooling the treated steel sheet, and then applying hot-dip galvanization to the steel sheet. A GA steel sheet is produced by subjecting alloying treatment to a GI steel sheet. However, in any GI steel sheet or GA steel sheet, the tensile strength thereof is made uneven between its center part and its edge parts, i.e., end parts in the width direction of the sheet, so that a large strength difference may be generated therebetween. However, in the above-mentioned literatures, Patent Literatures 1 to 4, no allowance is taken for such a strength difference between the center part and the end parts in the sheet width direction.

Attention has been paid to a situation as described above to make the present invention. An object thereof is to provide a high-strength hot-dip galvanized steel sheet (GI steel sheet), and a high-strength alloyed hot-dip galvanized steel sheet (GA steel sheet) that are each improved in bending workability, and are each decreased in strength difference between its center part and its end parts in the width direction of the sheet; and a method for manufacturing each of these steel sheets.

### Solution to Problem

The high-strength hot-dip galvanized steel sheet (GI steel sheet) according to the present invention, which has succeeded in solving the above-mentioned problems, is a hot-dip galvanized steel sheet having a hot-dip galvanization layer on a surface of a basic steel sheet; the basic steel sheet comprising: C: 0.05 to 0.25% (the symbol “%” denotes “% by mass”; the same applies to the proportion of any component described in the following), Si: 0.5% or less, Mn: 2.0 to 4%, P: 0.1% or less, S: 0.05% or less, Al: 0.01 to 0.1%, Ti: a proportion by mass that causes the following inequality (1) to be satisfied: 0.005×[Mn]+0.02×[B]^{1/2}+0.025≦[Ti] 0.15 (1) wherein each of the [ ] pairs represents the content by percentage (% by mass) of the element described in the [ ] pair, B: 0.0003 to 0.005%, N: 0.01% or less, and the remainder consisting of iron and inevitable impurities; in which the basic steel sheet has a metallic microstructure comprising martensite, bainite, and ferrite; the proportion of martensite in the whole of the metallic microstructure is 50% or more by area of the whole, the proportion of bainite therein is from 15 to 50% or more by area of the whole, and the proportion of ferrite therein is 5% or less by area of the whole.

The basic steel sheet may further contain, as one or more different elements,

(a) at least one of Cr: 1% or less (this expression not including 0%), and Mo: 1% or less (this expression not including 0%),

(b) at least one of Nb: 0.2% or less (this expression not including 0%), and V: 0.2% or less (this expression not including 0%), and/or

(c) at least one of Cu: 1% or less (this expression not including 0%), and Ni: 1% or less (this expression not including 0%).

The invention also includes a high-strength alloyed hot-dip galvanized steel sheet obtained, using the high-strength hot-dip galvanized steel sheet.

The high-strength hot-dip galvanized steel sheet of the invention can be manufactured by subjecting a cold rolled steel sheet (basic steel sheet) satisfying the above-mentioned component composition to soaking treatment at the Ac₃ point of the cold rolled steel sheet, or higher, cooling the steel sheet down to a cooling stop temperature of from 380° C. to 500° C. both inclusive at an average cooling rate of 3° C./second or more, subsequently keeping the steel sheet, as it is, for 15 seconds or longer, and then applying hot-dip galvanization to the steel sheet.

The high-strength alloyed hot-dip galvanized steel sheet of the invention can be manufactured by subjecting, after the above-mentioned application of the hot-dip galvanization, the resultant hot-dip galvanized steel sheet to alloying treatment.

### Advantageous Effects of Invention

According to the present invention, about a basic steel sheet constituting a high-strength hot-dip galvanized steel sheet or high-strength alloyed hot-dip galvanized steel sheet, the metallic microstructure thereof is rendered a mixed microstructure containing martensite and bainite, and is further decreased in the proportion of ferrite. Thus, the hot-dip or alloyed hot-dip galvanized steel sheet can be improved in bending workability. Moreover, on the basis of the respective proportions by mass of Mn and B, out of the composition components of the basic steel sheet, the content by percentage of Ti is appropriately adjusted; thus, the (alloyed) hot-dip galvanized steel sheet can be decreased in strength difference between its center part and its end parts in the sheet width direction.

### BRIEF DESCRIPTION OF DRAWINGS

FIG. 1 is a schematic chart referred to for describing manufacturing conditions in the present invention.

FIG. 2 is a graph showing a relationship between values “[Ti]−[Z] value” and strength difference ratios that were gained in working examples.

### DESCRIPTION OF EMBODIMENTS

As has been suggested in Patent Literature 4 by the inventors, when a steel sheet is bent, the steel sheet is cracked by a matter that stress is concentrated to an interface between its soft phase (ferrite) and its hard phase (martensite). Thus, in order to restrain the generation of the crack, it is necessary to decrease a difference in hardness between the soft phase and the hard phase. In the present invention, therefore, a steel sheet is made into a mixed metallic microstructure of martensite and bainite in which the proportion by area of ferrite, which is a soft phase, is controlled into 5% or less, and the proportion by mass of C, out of composition components of the steel, is controlled into 0.25% or less to decrease the hardness of martensite.

However, for an improvement of a steel sheet in bending workability, in the case of rendering the microstructure thereof a mixed metallic microstructure composed substantially of martensite and bainite as described above, the following is caused in the step of cooling the sheet, which is performed before the sheet is subjected to hot-dip galvanization treatment and after subjected to soaking treatment: a temperature difference is generated between sites of the sheet along the sheet width direction, so that the rate of bainite transformation is varied along the sheet width direction; thus, the steel sheet comes to have a strength difference generated between its center part and its end parts in the sheet width direction.

Thus, in order to reduce this strength difference, the inventors have further repeated investigations. As a result, the inventors have found out that it is good for solving the problem to use heat generated by bainite transformation. In other words, in a process for cooling a steel sheet after soaking treatment thereof, the sheet temperature is raised at its end parts by heat generated by bainite transformation at an initial stage of the step of keeping, after the stop of the cooling, the sheet at low temperature; and thus bainite transformation can be restrained at the last half of the low-temperature-sheet-keeping step. In order to use such heat generated by bainite transformation, it is necessary to set the bainite proportion in the whole of the metallic microstructure to 15% or more by area of the whole. In order to promote the bainite transformation at the low-temperature-sheet-keeping initial stage, Ti is positively added to the sheet to make austenite finer. However, if the steel sheet contains Mn and B, which have an effect of restraining the bainite transformation highly, in a large proportion by mass, the bainite transformation is unfavorably restrained at the low-temperature-sheet-keeping initial stage. Thus, in the present invention, it is necessary to set appropriately the lower limit value of the proportion by mass of Ti on the basis of the proportions by mass of Mn and B.

Hereinafter, the present invention will be specifically described, using a GI steel sheet as a typical example. The GI steel sheet of the invention is a sheet having a hot-dip galvanization layer on a surface of a basic steel sheet (meaning a steel sheet which is in a state before subjected to hot-dip galvanization). However, the invention is not limited to any GI steel sheet, and includes, in the scope thereof, any GA steel sheet.

The metallic microstructure of the basic steel sheet contains martensite, bainite, and ferrite, and the proportion of martensite in the whole of the metallic microstructure is 50% or more by area of the whole, the proportion of bainite therein is from 15 to 50% by area of the whole, and the proportion of ferrite therein is 5% or less by area of the whole. In other words, the steel sheet is improved in bending workability by making martensite, which is a hard phase, into a main constituent and making bainite, which is higher in hardness in ferrite, into a second phase and thus making a difference small in hardness between martensite and the second phase. As will be detailed later, in the present invention, the proportion by mass of C incorporated in the basic steel sheet is controlled into 0.25% or less, thereby decreasing the hardness of martensite so that a difference in hardness between martensite and bainite can be made as small as possible.

The species martensite is a phase necessary for heightening the GI steel sheet in tensile strength. If the proportion of martensite is less than 50% by area of the whole of the metallic microstructure, the steel sheet cannot ensure strength. Thus, the proportion of martensite is set to 50% or more by area, preferably to 60% or more by area, more preferably 70% or more by area. It is sufficient for the upper limit of the proportion of martensite to be 85% by area in order to ensure the production proportion of bainite that will be detailed later. If the proportion of martensite is large, the steel sheet is deteriorated in elongation to tend to be bad in strength/elongation balance. Thus, the proportion of martensite is more preferably set to 80% or less by area.

The species bainite is harder than ferrite. Thus, by rendering the second phase bainite, a hardness difference between this phase and martensite can be made small to improve the bending workability. In order to cause the steel sheet to ensure heat quantity generated by bainite transformation, and further restrain this sheet from undergoing, at its end parts in the sheet width direction, bainite transformation. The proportion of bainite is set to 15% or more by area of the whole of the metallic microstructure, preferably to 20% or more by area, more preferably 25% or more by area. In order for the steel sheet to ensure the above-mentioned production proportion of bainite, the upper limit of the proportion is set to 50% or less by area. If the proportion of bainite is large, the steel sheet does not easily ensure strength. Thus, the proportion of bainite is preferably set to 45% or less by area, more preferably to 40% or less b_{y} area.

The whole of the metallic microstructure in the present invention may be consist only of martensite and bainite, but may contain ferrite as far as the effects of the present invention are not damaged. It is however necessary to control the proportion of ferrite down to 5% or less by area of the whole of the metallic microstructure. The proportion of ferrite is preferably 4% or less by area, more preferably 3% or less by area, most preferably 0% by area.

It is sufficient for the respective proportions by area of the species martensite, bainite, and ferrite that the same proportions by area satisfy the afore-mentioned respective ranges at the center part in the sheet width direction of the basic steel sheet constituting the GI steel sheet or the GA steel sheet. Specifically, it is sufficient to cut a sample from a t/4 position (t: the sheet thickness) of a section of the basic steel sheet that is perpendicular to the sheet width direction, corrode the sample with nital, observe a measuring-target area (about 20 μm×about 20 μm) of the section, this area being present at any position of the section, through a scanning electron microscope (SEM) (observing power: 1500 magnifications), and then calculate out the proportions by area.

The basic steel sheet is characterized by containing Mn in a proportion by mass of 2.0 to 4%, B in a proportion by mass of 0.0003 to 0.005%, and Ti in a proportion by mass that causes the following inequality (1) to be satisfied:

0.005×[Mn]+0.02×[B]^{1/2}+0.025≦[Ti]≦0.15 (1)

wherein each of the [ ] pairs represents the content by percentage (% by mass) of the element described in the [ ] pair.

Ti is an element for making austenite fine, and for promoting bainite transformation at the end parts in the sheet width direction at the low-temperature-sheet-keeping initial stage to generate heat by the bainite transformation and further restraining the bainite transformation in the second half of the low-temperature-sheet-keeping step. In order to cause Ti to exhibit such effects, the proportion by mass of Ti is set on the basis of the proportions by mass of Mn and B, which are bainite-transformation-restraining elements, in the present invention.

However, Mn is an element acting effectively for restraining the production of ferrite and bainite to promote that of martensite, thereby heightening the steel sheet in strength. Mn is also an element for heightening the same in quenchability. Thus, the proportion by mass of Mn is set to 2.0% or more, preferably to 2.2% or more, more preferably to 2.4% or more. However, if the steel sheet excessively contains Mn, the sheet is deteriorated in galvanizability. Moreover, if the steel sheet excessively contains Mn so that Mn segregates, the strength is lowered. Mn is further an element for promoting P grain boundary segregation to make the grain boundaries brittle. Thus, the proportion by mass of Mn is set to 4% or less, preferably to 3.5% or less, more preferably to 3.0% or less.

In the same manner as Mn, B is an element for restraining the generation of ferrite and bainite to promote that of martensite, thereby heightening the steel sheet in strength. B is also an element for heightening the same in quenchability. Thus, the proportion by mass of B needs to be set to 0.0003% or more, and the proportion by mass is set preferably to 0.0005% or more, more preferably to 0.001% or more. However, if the steel sheet excessively contains B, a boride precipitates so that the sheet is deteriorated in bending workability and hot workability. Thus, the proportion by mass of B is set to 0.005% or less, preferably to 0.0045% or less, more preferably to 0.0040% or less.

In order to cause the steel sheet to exhibit the above-mentioned bainite-transformation-promoting effect based on the addition of Ti, it is necessary to incorporate Ti in a proportion by mass equal to or more the value of the left-hand side (0.005×[Mn]+0.02×[B]^{1/2}+0.025; the value may be referred to as the Z value hereinafter) of the inequality (1), this value being decided by the proportions by mass of Mn and B. The inventors have repeated experiments to find out the value of the left-hand side (the Z value) of the inequality (1). Each of the coefficients shows such a contribution factor that the element affects the restraint of the bainite transformation. However, if the steel sheet excessively contains Ti, fine carbides such as TiC precipitate so that the bending workability is deteriorated. Thus, the proportion by mass of Ti is set to 0.15% or less, preferably to 0.1% or less, more preferably to 0.09% or less.

The basic steel sheet contains, as alloying elements, Mn, B and Ti. Other composition components thereof need to satisfy the following: C: 0.05 to 0.25%, Si: 0.5% or less, P: 0.1% or less, S: 0.05% or less, Al: 0.01 to 0.1%, and N: 0.01% or less. Reasons why these ranges have been decided are as follows:

C is an element indispensable for improving the basic steel sheet in quenchability, and further hardening martensite to ensure the strength of the sheet. Thus, the proportion by mass of C is set to 0.05% or more, preferably to 0.10% or more, more preferably to 0.13% or more. However, if the proportion by mass of C is more than 0.25%, martensite is excessively hardened to be made large in difference between the hardness thereof and that of bainite or ferrite, so that the bending workability is deteriorated. Thus, the proportion by mass of C is set to 0.25% or less, preferably to 0.20% or less, more preferably to 0.18% or less.

Si acts as a solid-solution strengthening element to strength the basic steel sheet, thereby heightening the strength thereof. However, Si is an element for promoting the production of ferrite. Thus, if the steel sheet excessively contains Si, ferrite is produced in a large proportion so that a hardness difference becomes large between the produced regions thereof and those of martensite and bainite. Thus, the bending workability is conversely deteriorated. Additionally, the steel sheet is deteriorated in galvanizability if the steel sheet excessively contains Si. Thus, the proportion by mass of Si is set to 0.5% or less, preferably to 0.4% or less, more preferably to 0.3% or less. Si may be 0% (i.e., less than the detection limit).

P acts as a solid-solution strengthening element to strength the basic steel sheet, thereby heightening the strength thereof. However, if the steel sheet excessively contains P, the steel sheet is deteriorated in weldability, bending workability, and toughness. Thus, the proportion by mass of P is preferably made as small as possible. Thus, the proportion by mass of P is set to 0.1% or less, preferably to 0.03% or less, more preferably 0.015% or less.

S forms, in the basic steel sheet, sulfide inclusions (such as MnS). The inclusions each function as a crack origin to deteriorate the bending workability. Thus, the proportion by mass of S is set to 0.05% or less, preferably to 0.01% or less, more preferably to 0.008% or less.

Al is an element acting a deoxidizing agent. Thus, the proportion by mass of Al is set to 0.01% or more, preferably to 0.02% or more, more preferably to 0.030% or more. However, if Al is excessively incorporated into the steel, Al-containing inclusions (for example, oxides such as alumina) are increased to deteriorate the toughness and the bending workability. Thus, the proportion by mass of Al is set to 0.1% or less, preferably to 0.08% or less, more preferably to 0.05% or less.

N is an element contained inevitably in the steel sheet. If the steel sheet excessively contains N, the bending workability is deteriorated. Moreover, N is bonded to B in the steel to precipitate BN, thereby hindering the quenchability-improving effect of B. It is therefore desired to decrease N as much as possible. Thus, the proportion by mass of N is set to 0.01% or less, preferably to 0.008% or less, more preferably to 0.005% or less.

The basic component composition of the basic steel sheet is as described above. The remainder thereof is iron and inevitable impurities.

The basic steel sheet may contain, as other elements, alloying elements described in the following (a) to (c):

[(a) Cr: 1% or Less (the Expression not Including 0%), and/or Mo: 1% or Less (the Expression not Including 0%)]

Cr and Mo are each an element acting for improving the basic steel sheet in quenchability to improve the same in strength. Cr and Mo may be added thereto alone or in combination.

In particular, Cr is an element for restraining the production and growth of cementite to improve the steel sheet in bending workability also. In order to cause Cr to exhibit this effect effectively, the proportion by mass of Cr is preferably 0.01% or more, more preferably 0.03% or more, even more preferably 0.05% or more. However, if the steel sheet excessively contains Cr, the steel sheet may be deteriorated in galvanizability. Moreover, Cr carbides are produced in a large proportion by mass so that the bending workability may be deteriorated if the steel sheet excessively contains Cr. Thus, the proportion by mass of Cr is set preferably to 1% or less, more preferably to 0.8% or less, even more preferably to 0.7% or less, in particular preferably to 0.4% or less.

In order to cause the strength-improving effect based on the addition of Mo to be effectively exhibited, the proportion by mass of Mo is preferably 0.01% or more, more preferably 0.03% or more, even more preferably 0.05% or more. However, even if Mo is excessively incorporated into the steel, the addition-based effect is saturated so that costs increase. Thus, the proportion by mass of Mo is set preferably to 1% or less, more preferably to 0.5% or less, even more preferably to 0.3% or less.

[(b) Nb: 0.2% or Less (the Expression not Including 0%), and/or V: 0.2% or Less (the Expression not Including 0%)]

Nb and V are each an element acting for making the metallic microstructure fine to improve the basic steel sheet in bending workability. In order to cause Nb or V to exhibit this effect effectively, the proportion by mass of Nb is preferably 0.01% or more, more preferably 0.02% or more, even more preferably 0.03% or more. The proportion by mass of V is preferably 0.01% or more, more preferably 0.02% or more, even more preferably 0.03% or more. However, if the steel sheet excessively contains Nb and V, fine carbides precipitate in a large proportion so that the sheet may be deteriorated in bending workability. Thus, the proportion by mass of Nb is set preferably to 0.2% or less, more preferably to 0.15% or less, even more preferably to 0.1% or less. The proportion by mass of V is set preferably to 0.2% or less, more preferably to 0.15% or less, even more preferably to 0.1% or less. Nb and V may be added thereto alone or in combination.

[(c) Cu: 1% or Less (the Expression not Including 0%), and/or Ni: 1% or Less (the Expression not Including 0%)]

Cu and Ni are each an element acting for improving the basic steel sheet in strength. In order to cause Cu or Ni to exhibit this effect effectively, the proportion by mass of Cu is preferably 0.01% or more, more preferably 0.05% or more, even more preferably 0.1% or more. The proportion by mass of Ni is preferably 0.01% or more, more preferably 0.05% or more, even more preferably 0.1% or more. However, if the steel sheet excessively contains Cu and Ni, the steel sheet is deteriorated in hot workability. Thus, the proportion by mass of Cu is set preferably to 1% or less, more preferably to 0.8% or less, even more preferably to 0.5% or less. The proportion by mass of Ni is set preferably to 1% or less, more preferably to 0.8% or less, even more preferably to 0.5% or less. Cu and Ni may be added thereto alone or in combination.

The above has described the GI steel sheet of the present invention as a typical example thereof.

The hot-dip galvanization layer of the GI steel sheet may be alloyed. Thus, the present invention includes, in the scope thereof, any GA steel sheet obtained by subjecting the GI steel sheet to alloying treatment.

The following will describe a method for manufacturing each of the GI steel sheet and a GA steel sheet of the present invention.

The metallic microstructure of a basic steel sheet constituting each of the GI steel sheet and the GA steel sheet is rendered a metallic microstructure in which martensite is a main constituent, a bainite is produced into a predetermined proportion, and ferrite is restrained from being produced. For this microstructure, it is important to control appropriately conditions for soaking the basic steel sheet, and conditions for cooling after the soaking. Specifically, a cold rolled steel sheet satisfying the above-mentioned component composition is subjected to soaking treatment at a temperature in an austenite mono-phase temperature range that is equal to or higher than the Ac₃ point of the steel, thereby restraining the production of ferrite and promoting the production of martensite. After the soaking treatment, it is sufficient to cool the workpiece to a cooling stop temperature of from 380 to 500° C. both inclusive at an average cooling rate of 3° C./sec. or more, and keep the workpiece, as it is, for 15 seconds or longer, thereby producing martensite and bainite.

First, a description is specifically made about the method for manufacturing the GI steel sheet of the present invention.

A hot rolled steel sheet is prepared which has the above-mentioned component composition. It is sufficient for the hot rolling to be performed by an ordinary method. The heating temperature therefor is set preferably into the range of about 1150 to 1300° C. to ensure finishing temperature for the steel sheet, and prevent austenite grains from coarsening. It is preferred to finish-roll the workpiece at a finish rolling temperature of from 850 to 950° C. not to form any aggregate phase which hinders the workability of the steel, and then wind up the resultant.

After the hot rolling, the workpiece is washed with an acid in an ordinary manner if necessary, and then cold-rolled to produce a cold rolled steel sheet (basic steel sheet). The sheet width of the cold rolled steel sheet is, for example, 500 mm or more. According to the present invention, a strength difference of the steel sheet can be decreased between the center part and the end parts in the sheet width direction even when the sheet width is 500 mm or more.

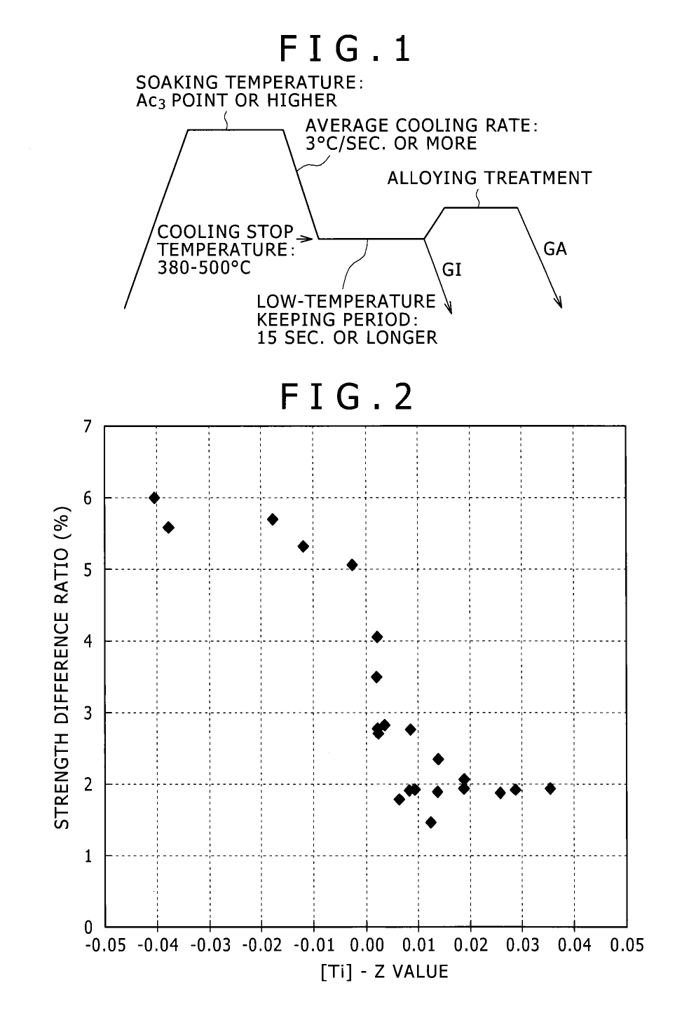

As illustrated in FIG. 1, after the cold rolling, the workpiece is heated and kept at a temperature of the Ac₃ point thereof or higher to be subjected to soaking treatment. This treatment makes it possible to restrain the production of ferrite and promote that of martensite. If the soaking treatment temperature is lower than the Ac₃ point, ferrite is produced in a large proportion to restrain the production of martensite. Accordingly, the steel sheet cannot be heightened in strength. Thus, the soaking treatment temperature is set to the Ac₃ point or higher, preferably to the “Ac₃ point+10° C.” or higher. The upper limit of the soaking treatment temperature is not particularly limited. However, if the temperature is higher than the “Ac₃ point+70° C.”, grains of austenite become coarse so that the bending workability may be deteriorated. Thus, the soaking treatment temperature is set preferably to the “Ac₃ point+70° C.”, or lower, more preferably to the “Ac₃ point+60° C.”, or lower.

The AC₃ point (ferrite transformation end temperature during steel-heating) is calculated out in accordance with the following equation (i):

Ac₃ (° C.)=910−203×[C]^{1/2}−15.2×[Ni]+44.7×[Si]+104×[V]+31.5×[Mo]+13.1×[W]−{30×[Mn]+11×[Cr]+20×[Cu]−700×[P]−400×[Al]−120×[As]−400×[Ti]} (i)

wherein each of the [ ] pairs represents the content by percentage (% by mass) of the element described in the [ ] pair. When the steel sheet does not contain any one of these elements, it is advisable to calculate out this temperature in the state that zero of “0% by mass” is substituted into the equation. This equation is described in “The Physical Metallurgy of Steels” (p. 73, written by William C. Leslie and published by Maruzen Co., Ltd.).

The period for which the soaking treatment is continued is not particularly limited, and may be, for example, from about 10 to 100 seconds (in particular, about 10 to 80 seconds).

As shown in FIG. 1, after the soaking treatment, the workpiece is cooled down to a cooling stop temperature of from 380 to 500° C. both inclusive at an average cooling rate of 3° C./sec. or more to produce martensite.

If the average cooling rate is less than 3° C./sec. at the time of cooling the workpiece from the soaking treatment temperature to the cooling stop temperature, ferrite and bainite are excessively produced in the middle of the cooling so that the steel sheet is deteriorated in bending workability. Thus, the average cooling rate is set to 3° C./sec. or more, preferably to 4° C./sec. or more. The upper limit of the average cooling rate is not particularly limited. Considering easiness of the control of the basic steel sheet temperature, and facility costs, it is advisable that the upper limit is about 100° C./sec. The average cooling rate is preferably 50° C./sec. or less, even more preferably 10° C./sec. or less.

If the cooling stop temperature is higher than 500° C. or lower than 380° C., a strength difference can be decreased between the center part and the end parts in the sheet width direction of the basic steel sheet. Thus, the cooling stop temperature is set to 500° C. or lower, preferably to 490° C. or lower, more preferably to 480° C. or lower, and is set to 380° C. or higher, preferably to 400° C. or higher, more preferably to 420° C. or higher.

It is advisable to control the cooling stop temperature in an ordinary manner on the basis of the temperature of the central position in the sheet width direction of the basic steel sheet.

After the stop of the cooling, hot-dip galvanization is applied to the workpiece in an ordinary manner to manufacture a GI steel sheet, provided that after the cooling stop and before the application of the hot-dip galvanization, the workpiece is kept as it is for 15 seconds or longer. This manner makes it possible to complete bainite transformation of the center part and the end parts in the sheet width direction to make, over the whole of the center part and the end parts, the metallic microstructure substantially even. If the period for workpiece-(as-it-is)-keeping after the cooling stop is shorter than 15 seconds, the bainite transformation is insufficiently attained so that a necessary proportion of bainite cannot be ensured. Thus, this workpiece-keeping period after the cooling stop is set to 15 seconds or longer, preferably to 25 seconds or longer, more preferably to 35 seconds or longer. The upper limit of the workpiece-keeping period after the cooling stop is not particularly specified. Considering the producibility, the length of a hot-dip galvanizing line to be used, and others, the limit is preferably about 1000 seconds.

The workpiece-keeping after the cooling stop is performed preferably at a temperature of from 380 to 500° C. both inclusive and of the “cooling stop temperature±about 60° C.”. In other words, it is not necessarily essential to conduct the workpiece-keeping at the cooling stop temperature, and thus the workpiece-keeping is allowable as far as the keeping is conducted in the range of temperatures of from 380 to 500° C. both inclusive and of the “cooling stop temperature±about 60° C.”.

In the hot-dip galvanization, the temperature of a bath for the galvanization is set preferably into the range of 400 to 500° C. (more preferably 440 to 470° C.).

The composition of the galvanization bath is not particularly limited, and may be a known bath for hot-dip galvanization.

After the hot-dip galvanization, the workpiece is cooled in an ordinary manner to yield a GI steel sheet having a desired microstructure. Specifically, after the hot-dip galvanization, the workpiece is cooled to room temperature at an average cooling rate of 1° C./sec or more to transform austenite in the basic steel sheet to martensite. In this way, a microstructure made mainly of martensite is yielded. If the average cooling rate is less than 1° C./sec., martensite is not easily produced so that perlite or a middle-stage transformation phase is unfavorably produced. The average cooling rate is set preferably to 5° C./sec or more. The upper limit of the average cooling rate is not particularly specified. Considering easiness of the control of the basic steel sheet temperature, and facility costs, it is advisable to set the upper limit to about 50° C./sec. The average cooling rate is preferably 40° C./sec or less, more preferably 30° C./sec or less.

The following will describe a method for manufacturing the GA steel sheet of the present invention.

The GA steel sheet can be manufactured by subjecting the above-mentioned GI steel sheet to alloying treatment. It is advisable that the alloying treatment is conducted by keeping the workpiece at about 500 to 600° C. (in particular, about 530 to 580° C.) for about 5 to 30 seconds (in particular, about 10 to 25 seconds) after the application of the hot-dip galvanization under the conditions as shown in FIG. 1.

The alloying treatment is conducted by use of, for example, a heating furnace, direct fire, or an infrared heating furnace. A heating manner therefor is not particularly limited, and may be a gas heating or induction heater heating manner (heating through a high-frequency induction heater), or any other conventional manner.

After the alloying treatment, the workpiece is cooled in an ordinary manner to yield a GA steel sheet having a desired microstructure. Specifically, after the alloying treatment, the workpiece is cooled to room temperature at an average cooling rate of 1° C./sec. or more to give a microstructure made mainly of martensite.

The GI steel sheet and the GA steel sheet of the present invention are each small in strength difference between the center part and the end parts in the sheet width direction of the steel sheet, and are further excellent in bending workability. Thus, the steel sheets of the invention are usable suitably as steel sheets for automobiles. In particular, the steel sheets of the invention are usable, in particular, for strength members of automobiles, for example, side members related to their front and rear regions, collision members such as a crush box, pillars such as a center pillar reinforce, and vehicle-constituting members such as a roof rail reinforce, a side sill, floor members, and kicking members.

The GI steel sheet and the GA steel sheet may be subjected to one or more out of various painting and painting surface-preparing treatments (for example, chemical treatments such as phosphate treatment), organic coating treatments (for example, organic coat formation such as film-lamination), and other treatments.

For the paint, a known resin is usable, examples thereof including epoxy resin, fluororesin, silicone acrylic resin, polyurethane resin, acrylic resin, polyester resin, phenol resin, alkyd resin, and melamine resin. Preferred are epoxy resin, fluororesin, silicone acrylic resin from the viewpoint of corrosion resistance. Together with one or more of these resins, a hardener may be used. The paint may contain known additives, such as a coloring pigment, a coupling agent, a levelling agent, a sensitizer, an antioxidant, an ultraviolet stabilizer, and a flame retardant.

In the present invention, the form of the paint is not particularly limited, and thus the paint may be a paint in any form, such as a solvent based paint, an aqueous paint, a water dispersed paint, a powdery paint or an electrodepositing paint.

The method for the painting is not particularly limited, and may be, for example, a dipping method, a roll coater method, a spraying method, a curtain flow coater method, or an electrodepositing method.

The thickness of the coat layer (plating layer, organic coat, chemical treatment coat or painted film, or some other layer) may be appropriately set in accordance with the use purpose of the steel sheet.

Hereinafter, the present invention will be more specifically described by way of working examples thereof. However, the invention is never limited by the examples. Of course, the examples may each be carried out in the state that an appropriate modification is applied thereto as far as the modified example can conform to the subject matters of the invention, which have been described hereinbefore or will be described hereinafter. Such modified examples are included in the technical scope of the invention.

The present application claims the benefit of the priority based on Japanese Patent Application No. 2012-72543 filed on Mar. 27, 2012. The entire contents of the Japanese Patent Application No. 2012-72543, filed on Mar. 27, 2012, are incorporated into the present application for reference.

### EXAMPLES

A slab having each component composition shown in Table 1 described later (the remainder thereof was iron and inevitable impurities) was heated to 1250° C. and then hot-rolled under a condition that the finish temperature thereof was set to 900° C. The workpiece was then wound up at a winding temperature of 620° C. to manufacture a hot rolled steel sheet.

The resultant hot rolled steel sheet was washed with an acid, and then cold-rolled to manufacture a cold rolled steel sheet (basic steel sheet). The length in the sheet width direction of the cold rolled steel sheet was 500 mm.

Table 1 and 2 described below show the component composition of each of the slabs, and the temperature of the Ac₃ point thereof, which was calculated out in accordance with the equation (i).

On the basis of the inequality (1) and the respective proportions by mass of B and Mn contained in the slab, a calculation was made about the value of the left-hand side (0.005×[Mn]+0.02×[B]^{1/2}+0.025) of the inequality (1). The resultant value is shown as the Z value in Table 1.

A calculation was also made about the value obtained by subtracting the Z value from the proportion by mass of Ti contained in the slab ([Ti]−Z value). The resultant value is shown in Table 2 as well as Table 1.

The resultant cold rolled steel sheets were each heated to a soaking temperature shown in Table 2 in a continuous hot-dip galvanization line. At this temperature, the steel sheet was kept for 50 seconds to be subjected to soaking treatment. The steel sheet was then cooled to a cooling stop temperature shown in Table 2 at an average cooling rate shown in Table 2. At this temperature, the steel sheet was kept as it was for a low-temperature keeping period (seconds) shown in Table 2, and then hot-dip galvanization was applied thereto, thereby manufacturing a hot-dip galvanized steel sheet (GI steel sheet: each of Nos. 20 to 22); or then hot-dip galvanization was applied thereto and subsequently the resultant was further heated to be subjected to alloying treatment, thereby manufacturing an alloyed hot-dip galvanized steel sheet (GA steel sheet: each of Nos. 1 to 19, and Nos. 23 to 31).

In each of these working examples of the present invention, the workpiece, i.e., the steel sheet was kept at a low temperature of the cooling stop temperature; however, it was also verified that the same advantageous effects were obtained when the workpiece-keeping temperature was in the range of temperatures of 380 to 500° C. and of the “cooling stop temperature±60° C.”.

The GI steel sheets were each manufactured by cooling the workpiece to the cooling stop temperature, immersing the workpiece in a hot-dip galvanizing bath of 460° C. temperature to apply hot-dip galvanization thereto, and then cooling the workpiece to room temperature.

The GA steel sheets were each manufactured by applying hot-dip galvanization to the workpiece, heating the workpiece to 550° C., keeping the workpiece at this temperature for 20 seconds to be subjected to the alloying treatment, and then cooling the workpiece to room temperature.

In Table 2 are shown respective galvanization species (GI or GA) of the steel sheets.

The metallic microstructure of each of the resultant GI steel sheets or GA steel sheets (hereinafter also referred to merely as the steel sheets) was observed through a process described below, and then measurements were made about the respective fractions of martensite, bainite and ferrite.

### <<Observation of Metallic Microstructure>>

About the metallic microstructure of the basic steel sheet constituting each of the GI steel sheets or GA steel sheets, a cross section thereof was made exposed at the central position in the sheet width direction of the steel sheet, this section being perpendicular to the sheet width direction. This cross section was polished, and further electrolytically polished. The cross section was then corroded with nital, and observed with an SEM. The position of the cross section where the observation was made was a t/4 position (t: the sheet thickness) thereof. A photograph of a metallic microstructure photographed through the SEM was subjected to image analysis, and then the ratio by area of each of martensite, bainite and ferrite was measured.

The observing power was 4000 magnifications, and the observed area was an area having a size of 20 μm×20 μm. The same observation was made about three visual fields of the cross section. The average value of the results was calculated. The calculation results are shown in Table 2.

Next, examinations were made about mechanical properties, and the bending workability of each of the resultant GI steel sheets and GA steel sheets.

### <<Mechanical Properties>>

JIS No. 13B test specimens were each collected (from each of the steel sheets) to make the rolling direction (L direction) of the steel sheet parallel to the longitudinal direction of the test specimen. In accordance with JIS Z2241, the tensile strength (TS) thereof was measured. Positions of the steel sheet where the test specimens were collected were two positions, i.e., a central position thereof in the sheet width direction (position 250 mm apart inward from any one of the end faces in the width direction of the steel sheet), and a position thereof 50 mm apart inward from the end face in the width direction of the steel sheet. The measured results are shown in Table 2. In Table 2, the column “Central part” shows the result obtained by using the test specimen collected from the position 50 mm apart inward from the end face in the width direction of the steel sheet; and the column “End parts” shows the result obtained by using the test specimen collected from the position 50 mm apart inward from the end face in the width direction of the steel sheet.

When the strength of the central part of any one of the steel sheets, and that of any one of the end parts thereof were each 980 MPa or more, the steel sheet was determined to have a “high strength”, and judged to be accepted for the present invention.

The difference in strength between the center part of the steel sheet and the end part thereof was evaluated through the strength difference percentage (also referred to as the strength difference ratio) calculated out in accordance with the following equation (ii):

Strength difference ratio (%)=[(“center part strength”−“end part strength”)/“center part strength”]×100 (ii)

The calculated-out strength difference ratios are shown in Table 2.

### <<Bending Workability>>

The bending workability of each of the steel sheets was evaluated on the basis of a bending test.

In the bending test, each test specimen having a size of 20 mm×70 mm was cut out from the steel sheet to make a direction perpendicular to the rolling direction of the steel sheet parallel to the longitudinal direction of the test specimen. The resultant test specimens were each used to make the bending test, which was a 90° V bending test, to make a bend ridgeline thereof consistent with the rolling direction of the steel sheet. The same tests were made while the bend radius R of the test specimens was appropriately varied. In this way, the minimum bend radius Rₘᵢₙ of the steel sheet, any test specimen of the sheet that has this radius or more being able to be bent without being cracked, was gained.

When any one of the steel sheets had a minimum bend radius Rₘᵢₙ of 3.0×t (t: the sheet thickness) or less, the steel sheet was excellent in bending workability (acceptable). When any one of the steel sheets had a minimum bend radius more than 3.0×t (t: the sheet thickness), the steel sheet was poor in bending workability (unacceptable). The evaluation results are shown in Table 2.

From Tables 1 and 2, a consideration can be made as follows: Nos. 1, 2, 4, 6 to 10, 12, 20, 21, 23, 30, and 31 are each an example satisfying the requirements specified in the present invention. Therein, the strength difference ratio between the center part and the end parts of the steel sheet is small and the bending workability is also good.

By contrast, Nos. 3, 5, 11, 13 to 19, 22, and 24 to 29 are each an example not satisfying one or more of the requirements specified in the present invention. Therein, the strength difference ratio between the center part and the end parts of the steel sheet is large or the bending workability is poor. Specifically, Nos. 3, 5 and 13 are examples in each of which the proportion by mass of Ti is too small for the proportions by mass of Mn and B contained in the basic steel sheet. Nos. 11 and 19 are examples in each of which Ti is not contained, and the value “[Ti]−Z value” is less than zero. Thus, the strength difference ratio between the center part and the end parts of the steel sheet is larger than 5%. Of these examples, No. 5 is an example in which additionally the proportion by mass of Si is too large; thus, ferrite is excessively produced so that the proportion of produced martensite cannot be ensured. Accordingly, No. 5 is also poor in bending workability.

No. 14 is an example in which the proportion by mass of Mn was too small, and thus ferrite is excessively produced. Thus, the example is deteriorated in bending workability. No. 15 is an example in which B is not contained, so that ferrite is excessively produced. Thus, the example is deteriorated in bending workability.

No. 16 is an example in which the soaking temperature is too low, and thus ferrite is excessively produced. Accordingly, the example is deteriorated in bending workability.

Nos. 17 and 27 are examples in each of which the cooling stop temperature is too low, and thus bainite is excessively produced. Accordingly, the proportion of produced martensite cannot be ensured. Thus, the strength difference ratio is large between the center part and the end parts of the steel sheet. Nos. 18 and 28 are examples in each of which the cooling stop temperature is too high, and thus the proportion of produced bainite cannot be ensured. Accordingly, the strength difference ratio is large between the center part and the end parts of the steel sheet.

No. 22 is an example in which the proportion by mass of C is too large, and thus the steel sheet is too high in strength to be deteriorated in bending workability. The reason why the strength is high would be that martensite is excessively hardened, and thus the hardness difference is too large between martensite and bainite so that the steel sheet is deteriorated in bending workability.

Nos. 24 and 26 are examples in each of which the average cooling rate after the soaking treatment is too small, and thus ferrite is excessively produced so that the proportion of produced bainite cannot be ensured. Accordingly, the strength difference ratio is large between the center part and the end parts of the steel sheet, and the bending workability is also deteriorated. No. 25 is an example in which the soaking temperature is too low, and thus ferrite is excessively produced so that the proportion of produced bainite cannot be ensured. Accordingly, the strength difference ratio is large between the center part and the end parts of the steel sheet, and the bending workability is also deteriorated.

No. 29 is an example in which the low-temperature keeping period after the stop of the cooling is too short, and thus the bainite transformation period is short so that the proportion of produced bainite cannot be ensured. Accordingly, the strength difference ratio is large between the center part and the end parts of the steel sheet.

Next, in a graph of FIG. 2 is shown a relationship between the respective values “[Ti]−Z value” of these examples and the respective strength difference ratios (%) thereof. In FIG. 2, data of the following examples, out of the data shown in Table 2, are not shown: the examples in which any one of the manufacturing conditions [the soaking temperature, the average cooling rate, the cooling stop temperature, or the low-temperature-keeping period] was out of the range specified in the present invention (specifically, Nos. 16 to 18, and “24 to 29).

As is evident from FIG. 2, when the value “[Ti]−Z value” is about zero, the strength difference ratio is remarkably changed. When the value “[Ti]−Z value” is 0 or more, the strength difference ratio is 5.0% or less.

TABLE 1

| Steel | Component composition (proportion: % by mass) | | | | | | | | | | | | | | | Ac₃ | Z | [Ti] − Z |
|---|---|---|---|---|---|---|---|---|---|---|---|---|---|---|---|---|---|---|
| species | C | Si | Mn | P | S | Al | Ti | B | N | Cr | Mo | Nb | V | Cu | Ni | (° C.) | value | value |
| A | 0.152 | 0.15 | 2.30 | 0.011 | 0.002 | 0.044 | 0.044 | 0.0032 | 0.0042 | — | — | — | — | — | — | 812 | 0.038 | 0.006 |
| B | 0.132 | 0.12 | 2.87 | 0.009 | 0.002 | 0.039 | 0.054 | 0.0026 | 0.0034 | — | — | — | — | — | — | 799 | 0.040 | 0.014 |
| C | 0.183 | 0.09 | 2.55 | 0.012 | 0.002 | 0.038 | 0.027 | 0.0038 | 0.0041 | 0.12 | — | — | — | — | — | 784 | 0.039 | −0.012 |
| D | 0.144 | 0.08 | 2.57 | 0.011 | 0.002 | 0.042 | 0.041 | 0.0030 | 0.0032 | 0.20 | — | — | — | — | — | 798 | 0.039 | 0.002 |
| E | 0.138 | 0.59 | 2.55 | 0.010 | 0.002 | 0.041 | 0.021 | 0.0029 | 0.0037 | 0.21 | — | — | — | — | — | 814 | 0.039 | −0.018 |
| F | 0.076 | 0.12 | 2.67 | 0.013 | 0.001 | 0.039 | 0.065 | 0.0021 | 0.0039 | 0.09 | — | — | — | — | — | 829 | 0.039 | 0.026 |
| G | 0.113 | 0.19 | 2.76 | 0.011 | 0.002 | 0.043 | 0.058 | 0.0011 | 0.0036 | — | — | — | — | 0.14 | 0.15 | 610 | 0.039 | 0.019 |
| H | 0.186 | — | 2.13 | 0.011 | 0.002 | 0.040 | 0.045 | 0.0023 | 0.0043 | 0.35 | — | 0.06 | 0.09 | — | — | 806 | 0.037 | 0.008 |
| I | 0.156 | — | 2.32 | 00.14 | 0.002 | 0.045 | 0.050 | 0.0022 | 0.0039 | — | 0.19 | — | — | — | — | 814 | 0.038 | 0.012 |
| J | 0.120 | 0.21 | 3.12 | 0.010 | 0.002 | 0.042 | 0.045 | 0.0024 | 0.0044 | — | — | — | — | — | — | 797 | 0.042 | 0.003 |
| K | 0.118 | — | 2.87 | 0.017 | 0.002 | 0.042 | — | 0.0035 | 0.0041 | — | — | — | — | — | — | 783 | 0.041 | −0.041 |
| L | 0.192 | — | 2.65 | 0.010 | 0.002 | 0.041 | 0.075 | 0.0040 | 0.0037 | 0.21 | — | — | — | 0.10 | 0.09 | 789 | 0.040 | 0.035 |
| M | 0.139 | — | 3.24 | 0.014 | 0.002 | 0.043 | 0.040 | 0.0045 | 0.0037 | — | — | — | — | — | — | 780 | 0.043 | −0.003 |
| N | 0.184 | — | 1.89 | 0.011 | 0.001 | 0.043 | 0.045 | 0.0029 | 0.0046 | — | — | — | — | — | — | 809 | 0.036 | 0.009 |
| O | 0.170 | — | 2.34 | 0.090 | 0.002 | 0.042 | 0.045 | — | 0.0051 | — | — | — | — | — | — | 854 | 0.037 | 0.008 |
| P | 0.145 | 0.06 | 2.54 | 0.015 | 0.002 | 0.041 | — | — | 0.0051 | 0.26 | 0.15 | — | — | — | — | 788 | 0.038 | −0.038 |
| Q | 0.271 | — | 2.08 | 0.011 | 0.002 | 0.039 | 0.065 | 0.0012 | 0.0045 | — | — | — | — | — | — | 791 | 0.036 | 0.029 |
| R | 0.090 | 0.01 | 2.60 | 0.004 | 0.003 | 0.028 | 0.041 | 0.0023 | 0.0026 | — | 0.15 | 0.02 | — | — | — | 807 | 0.039 | 0.002 |

TABLE 2

| | | | | | | | Low- | | | | | | | | |
|---|---|---|---|---|---|---|---|---|---|---|---|---|---|---|---|
| | | | | | Average | Cooling | temper- | | | | | | | Strength | |
| | | | | Soaking | cooling | stop | ature | | Metallic microstructures | | | Tensile strength | | differ- | |
| | Steel | | | temper- | rate | temper- | keeping | | (proportion: % by area) | | | (MPa) | | ence | Bending |
| | spe- | Ac₃ | [Ti] − Z | ature | (° C./ | ature | period | Galvani- | Fer- | Bai- | Martens- | Center | End | ratio | work- |
| No. | cies | (° C.) | value | (° C.) | sec.) | (° C.) | (sec.) | zation | rite | nite | ite | part | parts | (%) | ability |
| 1 | A | 812 | 0.006 | 830 | 5 | 430 | 50 | GA | 0 | 48 | 52 | 1164 | 1143 | 1.8 | Accepted |
| 2 | B | 799 | 0.014 | 830 | 5 | 480 | 50 | GA | 0 | 27 | 73 | 1267 | 1243 | 1.9 | Accepted |
| 3 | C | 784 | −0.012 | 830 | 5 | 430 | 50 | GA | 0 | 23 | 77 | 1367 | 1294 | 5.3 | Accepted |
| 4 | D | 798 | 0.002 | 830 | 5 | 430 | 50 | GA | 0 | 30 | 70 | 1256 | 1212 | 3.5 | Accepted |
| 5 | E | 814 | −0.018 | 830 | 5 | 430 | 50 | GA | 15 | 10 | 75 | 1313 | 1238 | 5.7 | Un- |
| | | | | | | | | | | | | | | | accepted |
| 6 | F | 829 | 0.026 | 840 | 5 | 430 | 50 | GA | 3 | 42 | 55 | 1007 | 988 | 1.9 | Accepted |
| 7 | G | 610 | 0.019 | 830 | 5 | 430 | 50 | GA | 1 | 39 | 60 | 1175 | 1151 | 2.0 | Accepted |
| 8 | H | 806 | 0.003 | 830 | 5 | 460 | 50 | GA | 1 | 31 | 68 | 1335 | 1298 | 2.6 | Accepted |
| 9 | I | 814 | 0.012 | 830 | 5 | 490 | 50 | GA | 0 | 38 | 62 | 1219 | 1201 | 1.5 | Accepted |
| 10 | J | 797 | 0.003 | 830 | 5 | 430 | 50 | GA | 0 | 18 | 84 | 1302 | 1265 | 2.8 | Accepted |
| 11 | K | 783 | −0.041 | 830 | 5 | 430 | 50 | GA | 0 | 34 | 66 | 1199 | 1127 | 6.0 | Accepted |
| 12 | L | 789 | 0.035 | 830 | 5 | 430 | 50 | GA | 0 | 18 | 82 | 1483 | 1454 | 2.0 | Accepted |
| 13 | M | 780 | −0.003 | 830 | 5 | 400 | 50 | GA | 0 | 15 | 84 | 1376 | 1306 | 5.1 | Accepted |
| 14 | N | 809 | 0.009 | 830 | 5 | 430 | 50 | GA | 23 | 19 | 59 | 1134 | 1112 | 1.9 | Un- |
| | | | | | | | | | | | | | | | accepted |
| 15 | O | 854 | 0.008 | 830 | 5 | 430 | 50 | GA | 7 | 34 | 59 | 1245 | 1221 | 1.9 | Un- |
| | | | | | | | | | | | | | | | accepted |
| 16 | A | 812 | 0.006 | 800 | 5 | 430 | 50 | GA | 10 | 23 | 67 | 1210 | 1176 | 2.8 | Un- |
| | | | | | | | | | | | | | | | accepted |
| 17 | D | 798 | 0.002 | 830 | 5 | 350 | 50 | GA | 0 | 58 | 44 | 1197 | 1132 | 5.4 | Accepted |
| 18 | D | 798 | 0.002 | 830 | 5 | 520 | 50 | GA | 0 | 14 | 86 | 1321 | 1232 | 6.7 | Accepted |
| 19 | P | 788 | −0.038 | 830 | 5 | 450 | 50 | GA | 0 | 31 | 69 | 1267 | 1196 | 5.6 | Accepted |
| 20 | B | 799 | 0.014 | 830 | 5 | 480 | 50 | GI | 0 | 26 | 74 | 1271 | 1241 | 2.4 | Accepted |
| 21 | G | 310 | 0.015 | 830 | 5 | 430 | 50 | GI | 1 | 38 | 61 | 1181 | 1158 | 1.9 | Accepted |
| 22 | Q | 791 | 0.029 | 820 | 5 | 430 | 50 | GI | 0 | 45 | 55 | 1543 | 1513 | 1.9 | Un- |
| | | | | | | | | | | | | | | | accepted |
| 23 | R | 807 | 0.002 | 850 | 5 | 460 | 50 | GA | 1 | 32 | 67 | 1185 | 1152 | 2.8 | Accepted |
| 24 | R | 807 | 0.002 | 850 | 2 | 460 | 50 | GA | 21 | 13 | 66 | 1191 | 1121 | 5.9 | Un- |
| | | | | | | | | | | | | | | | accepted |
| 25 | B | 799 | 0.014 | 780 | 5 | 460 | 50 | GA | 18 | 7 | 75 | 1278 | 1212 | 5.2 | Un- |
| | | | | | | | | | | | | | | | accepted |
| 26 | B | 799 | 0.014 | 830 | 2 | 480 | 50 | GA | 15 | 11 | 74 | 1242 | 1174 | 5.5 | Un- |
| | | | | | | | | | | | | | | | accepted |
| 27 | B | 799 | 0.014 | 830 | 5 | 360 | 50 | GA | 0 | 62 | 38 | 1178 | 1118 | 5.3 | Accepted |
| 28 | B | 799 | 0.014 | 830 | 5 | 520 | 50 | GA | 0 | 11 | 89 | 1318 | 1250 | 5.2 | Accepted |
| 29 | D | 798 | 0.002 | 830 | 5 | 430 | 10 | GA | 0 | 13 | 87 | 1325 | 1245 | 6.0 | Accepted |
| 30 | D | 798 | 0.002 | 830 | 5 | 430 | 20 | GA | 0 | 23 | 77 | 1280 | 1228 | 4.1 | Accepted |
| 31 | D | 798 | 0.002 | 830 | 5 | 430 | 100 | GA | 0 | 34 | 66 | 1242 | 1203 | 2.7 | Accepted |

1. A high-strength hot-dip galvanized steel sheet comprising a hot-dip galvanization layer on a surface of a basic steel sheet;
the basic steel sheet comprising iron and, by mass %:
C: from 0.05 to 0.25%,
Si: 0.5% or less (including 0%),
Mn: from 2.0 to 4%,
P: 0.1% or less (including 0%),
S: 0.05% or less,
Al: from 0.01 to 0.1%,
Ti: a proportion by mass satisfying inequality (1):
0.005×[Mn]+0.02×[B]^{1/2}+0.025≦[Ti]≦0.15 (1)
wherein [ ] represents the mass % of the element,
B: from 0.0003 to 0.005%,
N: from 0.01% or less (including 0%), and
the basic steel sheet has a metallic microstructure comprising martensite, bainite, and ferrite; wherein
the proportion of martensite in the whole of the metallic microstructure is 50% or more by area of the whole,
the proportion of bainite therein is from 15 to 50% er-mere by area of the whole, and
the proportion of ferrite therein is 5% or less by area of the whole.

2. The high-strength hot-dip galvanized steel sheet according to claim 1, wherein the basic steel sheet further comprises one or more of Cr: 1% or less (not including 0%), and Mo: 1% or less (not including 0%).

3. The high-strength hot-dip galvanized steel sheet according to claim 1, wherein the basic steel sheet further comprises one or more of Nb: 0.2% or less (not including 0%), and V: 0.2% or less (not including 0%).

4. The high-strength hot-dip galvanized steel sheet according to claim 1, wherein the basic steel sheet further comprises one or more of Cu: 1% or less (not including 0%), and Ni: 1% or less (not including 0%).

5. A high-strength alloyed hot-dip galvanized steel sheet, the steel sheet being obtained from the high-strength hot-dip galvanized steel sheet in claim 1.

6. A method for manufacturing a high-strength hot-dip galvanized steel sheet comprising:
subjecting a cold rolled steel sheet with the component composition of the basic steel sheet in claim 1 to soaking treatment at the Ac₃ point of the cold rolled steel sheet, or higher,
cooling the steel sheet to a cooling stop temperature of from 380° C. to 500° C. at an average cooling rate of 3° C./second or more,
keeping the steel sheet for 15 seconds or longer at the cooling stop temperature, and
applying hot-dip galvanization to the steel sheet.

7. A method for manufacturing a high-strength alloyed hot-dip galvanized steel sheet, further comprising
subjecting the high-strength hot-dipped galvanized steel sheet of claim 6 to an alloying treatment, thereby producing the high-strength alloyed hot-dip galvanized steel sheet.

8. A high-strength alloyed hot-dip galvanized steel sheet prepared by the method of claim 7.

9. A high-strength hot-dip galvanized steel sheet prepared by the method of claim 6.

10. The high strength hot-dip galvanized steel sheet according to claim 1, wherein the metallic microstructure comprises:
martensite: from 70 to 80%
bainite: from 25% to 40%
ferrite: 3% or less (including 0%).

11. The high strength hot-dip galvanized steel sheet according to claim 1, wherein the tensile strength of a central part and the tensile strength of an end part is 980 MPa or greater as determined according to JIS Z2241.

12. The high strength hot-dip galvanized steel sheet according to claim 11, wherein the strength difference percentage ratio between the center part and the end part of the steel sheet is less than 5% according to the following equation when the tensile strength is measured according to JIS Z2241:
Strength difference ratio (%)=[(“center part strength”−“end part strength”)/“center part strength”]×100.
